(19) United States
(12) Patent Application Publication
(10) Pub. No.: US 2002/0141110 A1
(43) Pub. Date: Oct. 3, 2002

(54) Motor assisted cartridge release

(76) Inventor: Amir Mohammadi, Ogden, UT (US)

Correspondence Address: DINSMORE & SHOHL, LLP, 1900 CHEMED CENTER, 255 EAST FIFTH STREET, CINCINNATI, OH, 45202, US

(21) Appl. No.: 09/822,116

(22) Filed: Mar. 30, 2001

(51) Int. Cl. G11B 17/04

(52) U.S. Cl. 360/99.07

(57) ABSTRACT

Devices adapted to be selectively coupled with a cartridge including a cartridge interface are provided. The device include a support structure and a device interface rotatably mounted to the support structure. The device interface is capable of being coupled with a cartridge interface to rotate at least a portion of a cartridge. The device further includes a mechanism for selectively decoupling the device interface from a cartridge interface. A drive assembly is also provided for rotating the device interface as a cartridge interface is being released from the device interface during at least one of coupling the cartridge interface to the device interface or decoupling the cartridge interface from the device interface. Methods of decoupling a cartridge interface from a device interface and methods of powering up an electrical device are also provided.

### TECHNICAL FIELD

This invention relates to an information storage apparatus, and more particularly to a mechanism for releasing a cartridge from an information device.

### BACKGROUND OF THE INVENTION

It is known to insert a cartridge into an information device to thereby form an information storage apparatus. A removable disk cartridge is typically used and comprises an outer casing or shell that houses a disk-shaped magnetic, magneta-optical or optical storage medium upon which the information can be stored. Magnetic disk media can be either rigid or flexible and are typically mounted on a hub that rotates freely about the cartridge casing. For instance, FIG. 1A discloses a rear view of a conventional disk cartridge 12 when the magnetic disk media is mounted on a portion or hub 18 of the cartridge 12.

When an operator has completed the use of a disk cartridge 12, a mechanism must be provided to decouple the disk cartridge 12 from the information device. However, decoupling the cartridge 12 from the information device may be interrupted or prevented by sticking or binding between the hub 18 of the disk cartridge 12 and a corresponding spindle of the information device. Similarly, sticking or binding may also occur between the hub and spindle during the process of coupling the disk cartridge with the information device. The sticking or binding can be caused by excessive friction forces resulting from a relatively high static coefficient of friction between the hub 18 and corresponding spindle.

### SUMMARY OF THE INVENTION

Accordingly, it is an object of the present invention to address and obviate problems and shortcomings of conventional information storage apparatus. More particularly, it is an object of the present invention to provide an assembly for releasing a disk cartridge interface from an information device interface in order to reduce or prevent sticking or binding between a cartridge interface and a device interface.

To achieve the foregoing in other objects in accordance with the present invention, devices are provided that are adapted to be selectively coupled with a cartridge including a cartridge interface. The device includes a support structure and a device interface rotatably mounted to the support structure wherein the device interface is adapted to be coupled with a cartridge interface to rotate at least a portion of a cartridge. The device further includes a mechanism for selectively decoupling the cartridge interface from the device interface. A drive assembly is also provided for rotating the device interface as a cartridge interface is being released from the device interface during at least one of coupling the cartridge interface to the device interface or decoupling the cartridge interface from the device interface.

To achieve further objects in accordance with the present invention, information storage apparatus are provided. Each information storage apparatus may comprise a device and a cartridge including a cartridge interface. The device includes a support structure and a device interface rotatably mounted to the support structure. The device interface is adapted to be coupled with the cartridge interface to rotate at least a portion of the cartridge. The device further includes a mechanism for selectively decoupling the device interface from the cartridge interface. A drive assembly is also provided for rotating the device interface as the cartridge interface is being released from the device interface during at least one of coupling the cartridge interface to the device interface or decoupling the cartridge interface from the device interface.

To achieve yet further objects in accordance with the present invention, methods of decoupling a cartridge interface of a cartridge from a device interface of a device are provided. The methods include the steps of sending a decoupling-release command signal to the device, decoupling the cartridge interface from the device interface in response to the command signal, and rotating the device interface while the cartridge interface is being decoupled from the device interface.

To achieve still further objects and in accordance with the present invention, methods of powering up an electrical device having a rotatable interface are provided. The methods include the steps of sending a power up command to the device, providing system power to the device, rotating the interface for a period of time in response to system power up, and stopping the interface from rotating after the period of time to await further instruction from an operator.

Still other advantages and objects of the present invention will become apparent to those skilled in the art from the following description wherein there are shown and described alternative exemplary embodiments of this invention. These exemplary advantages and objects are provided only as illustrative examples, and in no way are intended, nor should they be interpreted, as limiting or the only advantages or objects. As will be realized, the invention is capable of other different, obvious aspects, objects and embodiments, all without departing from the scope of the invention. These other objects, aspects and embodiments will be understood by those skilled in the art based upon the description and teachings herein. Accordingly, the drawings, objects and descriptions should be regarded as illustrative and exemplary in nature only, and not as restrictive.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a top plan view of an information storage apparatus in accordance with one exemplary embodiment of the present invention wherein the cartridge interface is decoupled from the device interface;

FIG. 1A is a rear view of a conventional cartridge;

FIG. 1B is portions of a mechanism for selectively decoupling the device interface from a cartridge interface;

FIG. 2 is a plan view of the information storage apparatus of FIG. 1 wherein the cartridge interface is coupled with the device interface;

FIG. 3 is a partial side sectional view of an information storage apparatus wherein the cartridge interface is coupled with the device interface;

FIG. 4 is a partial side sectional view of an information storage apparatus wherein the cartridge interface is in the process of being released from the device interface; and

FIG. 5 is a partial side sectional view of an information storage apparatus wherein the cartridge interface is decoupled from the device interface.

### DETAILED DESCRIPTION OF EXEMPLARY EMBODIMENTS

Turning now to the drawing figures in detail, wherein like numbers indicate like elements among corresponding views, information storage apparatus 10 are provided. It will be understood that the inventive concepts herein may involve an information storage apparatus in the form of a computer, a computer component, a portable or removable computer device, an audio storage device (e.g., portable audio device, for instance, to record and/or play music), a camera (e.g., portable camera), a video device (e.g., portable video device), and/or other electronic or portable electronic device having a cartridge.

The information storage apparatus 10 includes an information device and one or more cartridges. Each cartridge can be located at least partially within, or entirely within, the information device. In other examples, the at least one cartridge is adapted to be coupled to the information device without being inserted inside the information device.

The cartridge can include information storage media that might be magnetically sensitive, light or optically sensitive, chemically sensitive, biologically sensitive or otherwise reactive in order to store information such as digital, analog or other information. In exemplary embodiments, the information storage media can take the form of a rigid, flexible, or other media, in the shape of a disk or otherwise. Information to be stored could include multimedia (e.g., images, videos, audio), textual material, software programs, and/or other data.

The cartridge can include any selective coupling device having at least an interface (i.e., cartridge interface) adapted to be selectively coupled to an interface (i.e., device interface) of the information device such that a drive assembly may rotate at least a portion of the cartridge. The cartridge can include an optional casing or housing to at least partially house sensitive parts of the cartridge. Such a casing or housing can be partially or entirely omitted if desired. For instance, if located entirely within the information device at all times, the information device itself may provide the needed protection for the sensitive parts of the cartridge.

In certain exemplary embodiments, the information storage apparatus can include one or more cartridges that are adapted to be selectively coupled to one or more drive interfaces of the information device. In certain embodiments, the information device can be designed to select one or more of a plurality of the cartridges, depending on the information to be retrieved and/or stored.

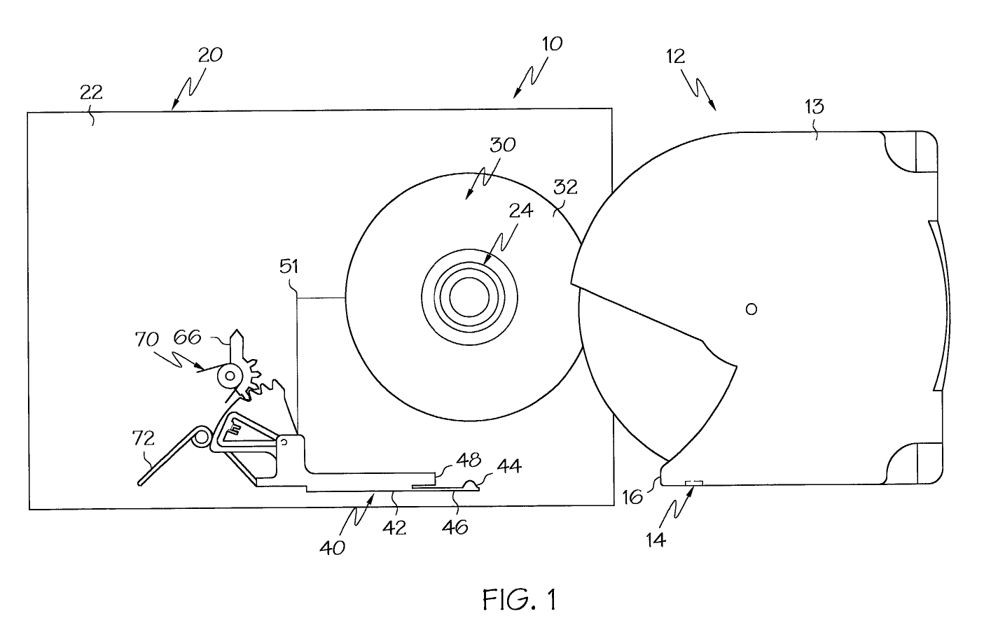

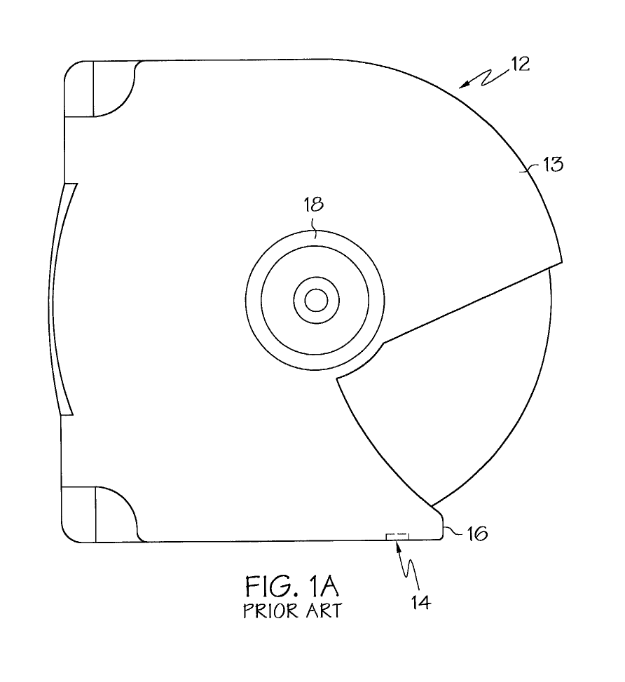

In another example, the cartridge can take the form of a separable cartridge that may be separated entirely from the information device. One exemplary cartridge that may be used with the concepts of the present invention is a separable disk cartridge such as the conventional disk cartridge 12 as best shown in FIGS. 1, 1A and 2. The disk cartridge 12 is illustrated for exemplary purposes only and it is understood that other cartridges could also be used with the inventive concepts described and claimed herein.

One conventional disk cartridge 12 that might be used in accordance with the present invention includes a cartridge interface 18, such as a hub, for rotating information storage media. If an optional casing or housing 13 is provided, the cartridge interface 18 will permit relative rotation between the information storage media and the housing 13. In the illustrated example, the information storage media is in the form of a magnetic disk mounted to the cartridge interface 18 (e.g., hub) for rotation relative to the housing 13. The optional housing 13 can further include an abutment surface 16 and notch 14 adapted to engage portions of the information device 20.

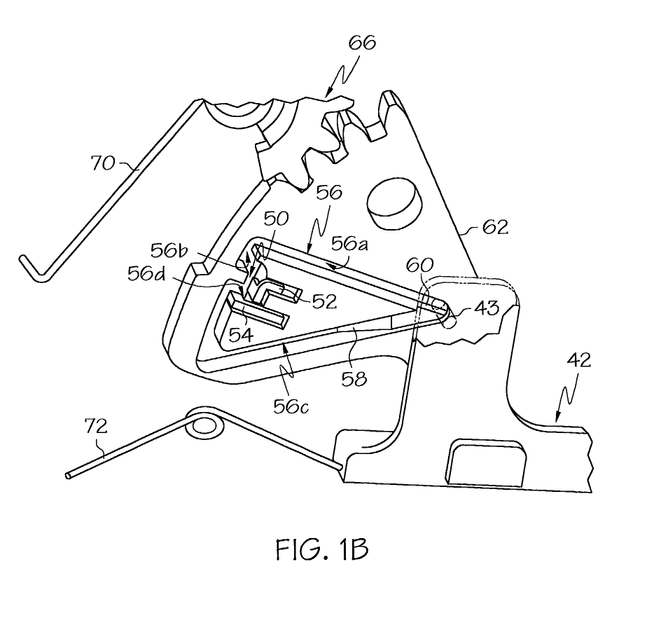

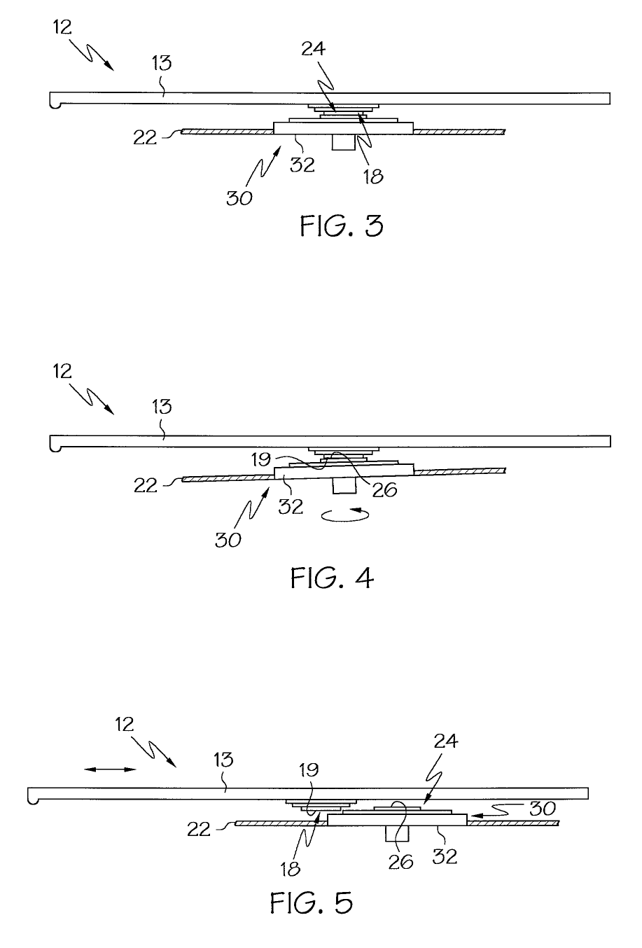

The information device 20 is adapted to be selectively coupled with one or more cartridges 12. In particular, the information device 20 can include a drive assembly 30 with a motor 32 for selective rotation of a device interface 24. As shown in FIGS. 1 and 3-5, the device interface 24 can comprise a spindle that is rotatably mounted to a support structure or chassis 22. For instance, the device interface 24 can be rotatably mounted to the motor 32 which in turn can be mounted to the chassis 22 as best illustrated in FIGS. 3-5. As best illustrated in FIGS. 1A and 3-5, the cartridge interface 18 can comprise a hub adapted to be coupled with the spindle. It will be appreciated that the interfaces could comprise other configurations and/or shapes so long as the device interface can transmit torque from the motor to the cartridge interface. For instance, the interfaces could comprise keyed members, friction disks, or other linking members. In another example, the configurations of the interfaces could be reversed (e.g., the cartridge interface could comprise a spindle while the device interface comprises a hub).

The drive assembly 30 of the information device 20 includes a motor 32 adapted to cause selective rotation of the device interface 24 which in turn engages and selectively rotates the cartridge interface 18. In one embodiment, the information storage apparatus is adapted to cause rotation of the device interface 24 while the cartridge interface 18 is being decoupled and released from the device interface 24. In another embodiment, the information storage apparatus 10 is adapted to cause rotation of the device interface 24 to release the cartridge interface 18 from the device interface 24 while coupling the cartridge interface 18 to the device interface 24. In still another embodiment, the information storage apparatus 10 is adapted to cause rotation of the device interface 24 for a limited period of time in response to system power to decouple and release the cartridge interface 18 from the device interface 24. The information storage apparatus is also adopted to stop rotation of the device interface 24 from rotating after the period of time to await further instructions from an operator.

The term “releasing” throughout this application is intended to connote reducing or preventing the occurrence of binding between the device interface surface 19 and the cartridge interface surface 26 during coupling and/or decoupling of the cartridge interface 18 to/from the device interface 24.

Releasing the cartridge interface 18 from the device interface 24 while coupling the interfaces may be initiated by sending a coupling-release command to the device. The coupling-release command could take the form, for example, of an operator simply moving the cartridge 12 relative to the information device 20. For instance, the coupling release command can involve an operator inserting a cartridge 12 at least partially into the information device 20. A detector such as a switch or other sensor may detect the presence of the cartridge 12 as its being moved relative to the information device 20. After the detector receives the coupling-release command from an operator, a signal is then sent to actuate the drive assembly 30 in response to the operator sending the coupling-release command to the information device 20. Accordingly, by actuating the drive assembly 30 in response to the coupling-release command, the cartridge interface 18 is released from the device interface 24 as the interfaces are coupled.

Decoupling and releasing the cartridge interface 18 from the device interface 24 may be initiated by sending a decoupling-release command to the device. The decoupling-release command can take the form of an operator simply pressing a button. Alternatively or in addition, the command may be electronic or the output of a program. For instance, the information storage device may be programed to decouple and release the cartridge 12 from the information device 20 after the occurrence of an event (e.g., lapse of a predetermined period of time, after reaching the end or a predetermined location of the information storage media, after being dropped or sensing an impact force, etc.). At this time the program could output a decoupling-release command to the device to decouple and release the cartridge therefrom. In still other examples, the decoupling-release command could take the form of an operator pressing against the cartridge or other part of the information storage apparatus.

As illustrated in FIGS. 1, 1B, and 2, an exemplary mechanism 40 can be provided including an arrangement adapted to actuate the drive assembly 30 in response to an operator sending a decoupling-release command by pressing against the cartridge 12. The exemplary mechanism 40 is also adapted to selectively decouple the cartridge interface 18 from the device interface 24.

The information device 20 may also include one or more detectors. The detector can take many alternative forms that are designed to sense the presence and/or position of a cartridge. In one example, the detector is adapted to sense a cartridge being moved to be coupled with the information device. In another example, the detector can sense when a cartridge is positioned such that the cartridge interface is coupled with the device interface. The detector is also capable of receiving a release command from an operator and may also be adapted to send a signal to the drive assembly after receiving the release command from the operator. The detector, for instance, can take the form of a proximity sensor, a switch, a mechanical linkage, or other detecting device.

Although not shown, the detector can be provided separate from the mechanism 40. For instance, a switch could be provided to interfere with a portion of the cartridge in a coupled position and/or as the cartridge is moving to the coupled position. Alternatively, or in addition, as best shown in FIGS. 1 and 1B, the mechanism 40 could comprise the detector 50, thereby reducing the number of separate parts and simplifying the design.

As best illustrated in FIG. 1B, the exemplary detector 50 can comprise a first contact 52, such as an L-shaped contact, and a second contact 54, such as a side contact. The first contact 52 is spaced from the second contact 54 to provide an open circuit in the absence of a properly positioned conductive protuberance 43. In one particular embodiment, as best shown in FIG. 1B, the detector 50 is at least partially located within a substantially triangular shaped groove 56.

FIG. 1 illustrates and exemplary mechanism 40 in accordance with the present invention. The mechanism 40 may include a sliding lever 42 with an abutment surface 48 for engaging the abutment surface 16 of the disk cartridge 12. The mechanism 40 may also include a flexible arm 46 having a protuberance 44 for engaging within the notch 14 of the disk apparatus 12. The engagement between the protuberance 44 and the notch 14 and abutment between the abutment surface 16 and abutment surface 48 are more fully disclosed in U.S. Pat. No. 6,055,125, issued Apr. 25, 2000, the entire patent herein incorporated by reference.

As illustrated in FIGS. 1, 1B and 2, the sliding lever 42 is biased outwardly by lever spring 72 to an outward position illustrated in FIG. 1. As best seen in FIG. 1B, the mechanism 40 further includes pinion 62 operably engaged with a spring loaded gear 66. The gear 66 is adapted to control the loading and unloading of the read-write heads of the information device as disclosed more fully in U.S. Pat. No. 6,055,125. Gear spring 70 is provided to bias the gear 66 in a counter-clockwise direction into a loaded non-use position as illustrated in FIG. 1. As the cartridge 12 is coupled with the information device 20, the gear 66 is rotated clockwise to releases the read-write heads (not shown) as illustrated and described in U.S. Pat. No. 6,055,125.

As best seen in FIG. 1B, the pinion 62 includes a substantially triangular groove 56 having a first channel 56a, a second channel 56b, and a third channel 56c. As disclosed in U.S. Pat. No. 6,055,125, the first channel 56a includes a drop off 60 to prevent a protuberance 43 from rotating in a clockwise orientation with respect to the substantially triangular groove 56. The protuberance 43 includes conductive material and is adapted to engage the detector 50 such that it is seated within the second channel 56b at location 56d to simultaneously abut both contacts 52, 54; thereby closing the circuit. When the circuit is closed, the cartridge is located in a position wherein the cartridge interface is coupled with the device interface (as illustrated in FIGS. 2 and 3). In order to decouple the cartridge 12 from the device 20, the operator may send a decoupling-release command signal to the device by pushing against the cartridge 12. In response to the decoupling-release command, the cartridge interface 18 begins to decouple from the device interface 24 while the conductive protuberance 43 disengages from the contact location 56d to thereafter travel within the third channel 56c. The detector 50, upon detection of the open circuit resulting from disengaging conductive protuberance 43 from the contact location 56d, causes the transmission of a release signal to the drive assembly 30, thereby actuating the motor 32 to cause rotation of the device interface 24 for a limited period of time as the cartridge interface 18 is decoupled and released from the device interface 24.

A conductor or wire 51 may be provided to transmit the signal from the detector 50 to actuate the motor 32. The motor 32 may include a controller to affect the rotation of the device interface 24. Alternatively, the controller may be provided separate from the motor (not shown) such that the signal is sent from the detector 50 to the controller, which in turn sends a command to the motor 32.

One example of using the device of the present invention includes releasing the cartridge interface 18 from the device interface 24 while coupling the interfaces. Coupling and releasing involves inwardly moving the cartridge 12 relative to the information device 20 (e.g., by inserting the cartridge 12 into the information device 20) to send a coupling-release command to the information device 20. For instance, a detector, such as a switch, could be triggered as the cartridge 12 is moved relative to the information device 20. The detector may then send a release signal to the motor 32 of the drive assembly 30 to cause rotation of the device interface 24 for a limited period of time. Accordingly, the device interface 24 is rotated while the cartridge interface 18 is being released from and coupled to the device interface 24. During the coupling process, the cartridge 12 is moved relative to the information device until the protuberance 44 engages with notch 14 of the cartridge 12 and the abutment surface 16 of the cartridge 12 abuts the surface 48 of the sliding lever 42. Further inward movement of the disk 12 relative to the information device 20 causes inward movement of the sliding lever 42 against the bias of the biasing member, or spring 72. As the sliding lever 42 moves inwardly, the protuberance 43 of the sliding lever 42 slides within the first channel 56a causing a counter clockwise movement of the pinion 62 against the bias of spring-loaded gear 66. The counter-clockwise rotation of the pinion 62 causes a clockwise rotation of the gear 66, thereby releasing the read-write heads (not shown) as described in U.S. Pat. No. 6,055,125.

Once the cartridge 12 has been fully inserted within the information device 20, the protuberance 43 engages a rear portion of the first channel 56a thereby providing a stop and indicating to the operator that the cartridge 12 has been fully inserted. After the operator disengages the cartridge 12, the gear 66 biases the pinion 62 into a clockwise rotation such that the protuberance 43 enters within the second channel 56b. As shown in FIG. 2, the protuberance 43 continues to travel within the second channel 56b until it reaches a contact location 56d thereby engaging the detector 50 and providing a closed circuit by simultaneously abutting the first contact 52 and the second contact 54. When the protuberance 43 is located at the contact location 56d, the cartridge interface 18 is coupled with the device interface 24 as illustrated in FIG. 3.

To decouple and release the cartridge interface 18 from the device interface 24, the operator sends a decoupling-release command signal to the device 20, for example, by again pushing the cartridge 12 inwardly to dislodge the protuberance 43 from the contact location 56d to open the circuit of the detector 50. The pinion 62 then rotates clockwise until the protuberance 43 reaches the third channel 56c. The lever spring 72 then urges the protuberance 43 to slide within the third channel 56c up a ramp 58 until it drops over the drop-off 60 and back into the first channel 56a to a decoupled position as illustrated in FIG. 1. Thus, lever spring 72 biases the sliding lever 42 of the mechanism 40 to decouple the cartridge interface 18 from the device interface 24 in response to the command signal.

Once the protuberance 43 disengages from the contact location 56d, the closed circuit between first contact 52 and second contact 54 is opened thereby causing a release signal to travel through conductor 51 to the motor 32 of the drive assembly 30 to cause rotation of the device interface 24 for a limited period of time. Accordingly, the device interface 24 may be rotated while the cartridge interface 18 is being decoupled and released from the device interface 24.

If the system is powered down before the cartridge interface 18 is decoupled from the device interface 24, binding may occur between a cartridge interface surface 26 and the device interface surface 19, thereby interfering with or preventing the decoupling of the cartridge interface 18 from the device interface 24. Similarly, binding may occur between the cartridge interface surface 26 and the device interface surface 19 if the system is powered down before the cartridge interface 18 is coupled to the device interface 24. Such binding may also interfere with or prevent the coupling of the cartridge interface 18 to the device interface 24. In accordance with the present invention, a method of powering up the device is provided to release any previous binding. First, a power up command is sent to the device. For example, an operator may press a power switch to send the power command to the device 20. System power is provided to the device 20 in response to the power up command and the device interface 24 is rotated for a period of time. The device 20 then stops the rotation of the device interface 24 after a period of time to await further instruction from an operator. Accordingly, any binding that might exist between the cartridge interface surface 19 and the device interface surface 26 may be reduced or prevented by the initial rotation of the device interface 24 in response to system power-up, thereby permitting complete coupling or decoupling of the interfaces.

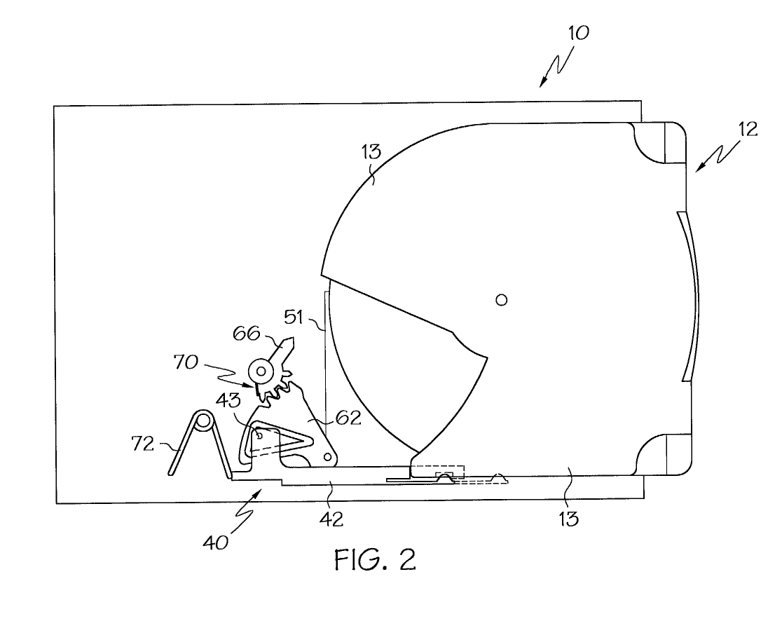

As illustrated in FIG. 4, release of the cartridge interface 18 from the device interface 24 is the result of rotation of the device interface 24 as the cartridge interface 18 is being coupled to, or decoupled from, the device interface 24. Indeed, relative rotation may cause sliding between a device interface surface 26 and corresponding cartridge interface surface 19; thereby providing a lower dynamic or sliding friction between the surfaces. Accordingly, the sliding relationship between the surfaces reduces or prevents the occurrence of binding due to any static friction that might otherwise occur between the cartridge interface surface 19 and the device interface surface 26.

The foregoing description of the various embodiments of the invention has been presented for the purposes of illustration and description. It is not intended to be exhaustive or to limit the invention to the precise form disclosed. Many alternatives, modifications and variations will be apparent to those skilled in the art of the above teaching. Accordingly, this invention is intended to embrace all alternatives, modifications and variations that have been discussed herein, and others that fall within the spirit and broad scope of the claims.

What is claimed is:

1. A device adapted to be selectively coupled with a cartridge including a cartridge interface, the device comprising:
a) a support structure,
b) a device interface rotatably mounted to the support structure, the device interface being adapted to be coupled with a cartridge interface to rotate at least a portion of a cartridge,
c) a mechanism for selectively decoupling a cartridge interface from the device interface, and
d) a drive assembly for rotating the device interface as a cartridge interface is being released from the device interface during at least one of coupling the cartridge interface to the device interface or decoupling the cartridge interface from the device interface.

2. The device of claim 1, wherein the drive assembly is for rotating the device interface as the cartridge interface is being released from the device interface when coupling the cartridge interface to the device interface or when decoupling the cartridge interface from the device interface.

3. The device of claim 1, wherein the drive assembly is for rotating the device interface as the cartridge interface is being released from the device interface when coupling the cartridge interface to the device interface and when decoupling the cartridge interface from the device interface.

4. The device of claim 1, further comprising a detector adapted to receive a release command from an operator.

5. The device of claim 4, wherein the detector is adapted to send a signal to the drive assembly after receiving a release command from an operator.

6. The device of claim 4, wherein the mechanism includes the detector.

7. The device of claim 1, wherein the mechanism defines a generally triangular shaped groove.

8. The device of claim 7, further comprising a detector adapted to receive a release command from an operator.

9. The device of claim 8, wherein the detector is adapted to send a signal to the drive assembly after receiving a release command from an operator.

10. The device of claim 8, wherein the mechanism includes the detector.

11. The device of claim 10, wherein the detector is at least partially located within the groove.

12. The device of claim 1, wherein the drive assembly rotates the device interface in response to system power up and stops the device interface from rotating after a period of time following system power up.

13. An information storage apparatus comprising a device and a cartridge including a cartridge interface, wherein the device comprises:
a) a support structure,
b) a device interface rotatably mounted to the support structure, the device interface being adapted to be coupled with the cartridge interface to rotate at least a portion of the cartridge,
c) a mechanism for selectively decoupling the device interface from the cartridge interface, and
d) a drive assembly for rotating the device interface as the cartridge interface is being released from the device interface during at least one of coupling the cartridge interface to the device interface or decoupling the cartridge interface from the device interface.

14. The device of claim 13, further comprising a detector adapted to receive a release command from an operator.

15. The device of claim 14, wherein the detector is adapted to send a signal to the drive assembly after receiving a release command from an operator.

16. The device of claim 14, wherein the mechanism includes the detector.

17. The device of claim 13, wherein the mechanism defines a generally triangular shaped groove.

18. The device of claim 17, further comprising a detector adapted to receive a release command from an operator.

19. The device of claim 18, wherein the detector is adapted to send a signal to the drive assembly after receiving a release command from an operator.

20. The device of claim 18, wherein the mechanism includes the detector.

21. The device of claim 20, wherein the detector is at least partially located within the groove.

22. The device of claim 13, wherein the drive assembly rotates the device interface in response to system power up and stops the device interface from rotating after a period of time following system power up.

23. A method of decoupling a cartridge interface of a cartridge from a device interface of a device comprising the steps of:
a) sending a decoupling-release command signal to the device,
b) decoupling the cartridge interface from the device interface in response to the command signal, and
c) rotating the device interface while the cartridge interface is being decoupled from the device interface.

24. A method of powering up an electrical device having a rotatable interface comprising the steps of:
a) sending a power up command to the device,
b) providing system power to the device,
c) rotating the interface for a period of time in response to system power up, and
d) stopping the interface from rotating after the period of time to await further instruction from an operator.
